(19) United States
(12) Patent Application Publication
(10) Pub. No.: US 2009/0240794 A1
(43) Pub. Date: Sep. 24, 2009

(54) TECHNIQUES UTILIZING A LAYER-2 PROXY FOR ENERGY-EFFICIENT SERVICE DISCOVERY AND CONNECTIVITY IN NETWORKS

(76) Inventors: Huaiyu Liu, Portland, OR (US); Victor Lortz, Beaverton, OR (US)

Correspondence Address: INTEL CORPORATION;c/o CPA Global, P.O. BOX 52050, MINNEAPOLIS, MN, 55402, US

(21) Appl. No.: 12/052,219

(22) Filed: Mar. 20, 2008

(51) Int. Cl. G06F 15/173

(52) U.S. Cl. 709/223

(57) ABSTRACT

An embodiment of the present invention provides a method of server energy conservation in networks, comprising integrating a layer-2 service discovery proxy with an access point (AP) in the network, wherein the AP advertises the services on behalf of servers in the network to enable the servers to go to a low power state and conserve energy.

### BACKGROUND

Today, network devices that provide services (henceforth called “servers”), such as printing, projecting, display, and file sharing services, need to remain online to respond to requests from client devices (“clients”) that need the services. However, power conservation is also of foremost importance. Furthermore, many devices today are becoming mobile, with wireless network interfaces and limited battery power. These devices need to be able to efficiently search for or advertise their own services without quickly depleting their batteries

Thus, a strong need exists for techniques for energy-efficient service discovery and connectivity in networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a sample procedure for performing layer-2 proxy based energy conservation, service discovery, and service connection in an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device or a handheld PDA device.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Embodiments of the present invention provide integrating a proxy with an access point (AP), such as but not limited to a wireless access point, to function as layer-2 proxy for energy-saving service discovery. Integrating a proxy with layer-2 service discovery is also novel to the present invention, which allows client devices to discovery services in a network without the need to connect to the network. Furthermore, the layer-2 proxy in embodiments of the present invention enables both server and client devices to disconnect from the wireless network while remaining able to reconnect when needed, thereby eliminating the burden of maintaining network connectivity and further reducing power consumption.

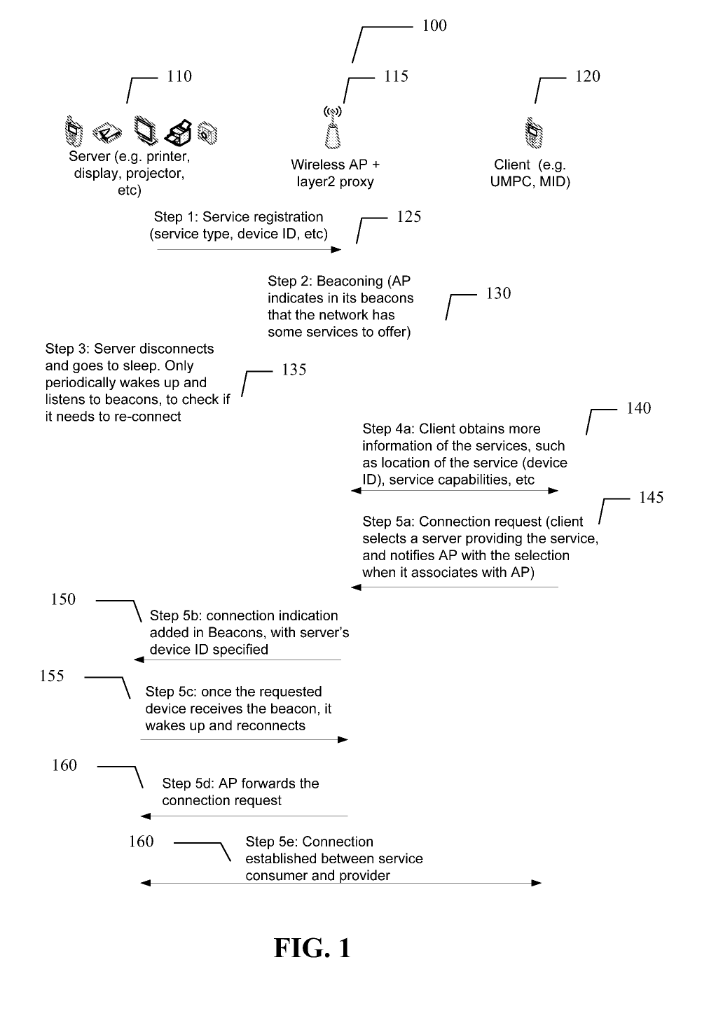

An embodiment of the present invention as generally shown as 100 of FIG. 1 addresses energy conservation of servers 110 (e.g., printer, display projector etc.) in a network connected by a wireless AP/router 115, and provides a light-weight layer-2 solution included therein 115. Essentially, it integrates a layer-2 service discovery proxy with the AP. The wireless AP 115 advertises the services on behalf of servers 110 so that the servers can go to a low power state and conserve energy. Furthermore, a server 110 using the proxy can save even more power by disconnecting from the network and periodically listening to beacons to determine if it should wake up and reconnect.

Continuing with FIG. 1 is a sample procedure for performing layer-2 proxy based energy conservation, service discovery, and service connection in an embodiment of the present invention. Embodiments of the present invention may include the following components and procedures:

1. Service registration 125: If a server wishes to conserve energy while it is idle, it registers its services, device ID, etc. with the wireless AP proxy.

2. Layer-2 service discovery proxy: the proxy in the AP records the service information registered by servers, and then indicates in its beacons 130 that these services are available. To conserve beacon bandwidth, some of the service details are typically omitted from the beacon frames.

3. The server can now go to low power state 135. For instance, it typically goes to sleep, and only periodically wakes up to listen to beacons and maintain connectivity (on some devices, only the network interface card (NIC) remains on to maintain its connection with the AP). The server may even completely disconnect from the AP and periodically wake up, listen to beacons, and check if it needs to reconnect in case its service is requested.

4. Layer-2 proxy based service discovery 140: First, when a client device 120, such as an ultra mobile device, searches for services in the network, it finds that layer-2 service discovery is supported by the network and the AP functions as the service discovery proxy. Client devices could discover services advertised by the AP either through broadcast (e.g. beacons or some other layer-2 messages) or directed messages (e.g. by exchanged Probe Requests and Probe Responses), or a combination of both.

It is noted that that in this step, the client could be already connected to the network (inside), or it may not be connected yet (outside). This also enables a client to disconnect from the network to save power once it is done utilizing a service. There is no need for the client to remain connected to keep track of service updates or new announcements since those are taken care of by the proxy.

5. AP supported connection establishment 145: When the client picks a particular server and requests to connect to it, the request will be recognized by the AP. If the server remains connected to the AP when it is in low power mode, the AP can wake it up through mechanisms such as wake-on-LAN and wake-on-wireless (similar to wake-on-LAN, where a magic packet could wake up a device)—it is understood the present invention is not limited in this respect. If the server is disconnected and only periodically examines beacons, the AP then indicates in its beacons 150 that the server needs to reconnect (e.g. includes the provider's device ID in the beacon and set a bit to indicate reconnection is needed). Then it is the responsibility of the server to reestablish the connection when its device ID is seen in beacons. Once the server wakes up and connects to AP 155, the AP may then forward the connection request so that the server and client can connect to each other. At 160 the AP forwards the connection request and at 165 connection establishment between client and server is accomplished.

It is noted that if the client was not connected to the network yet in step 4, the procedure for it to connect to the network may be integrated into step 5. For instance, in the example shown in FIG. 1, but not limited in this respect, in step 5, while client associates with the AP (i.e. connecting to the network), it also indicates the server it wants to use.

As provided herein, embodiments of the present invention enables servers to even disconnect from AP to further save power, by saving the cost of maintaining network connectivity, including layer-2 connection maintenance, replying to ARP requests, maintaining DHCP states, etc. Further, it enables easy detection of proxy failure since the proxy feature is integrated into the AP itself and can be inferred from the presence of layer 2 service discovery and server wakeup information elements in the beacons. Alternative methods based on higher-layer protocols make it much more difficult for servers to know if proxies continue to remain operational in the network. Also, by applying the proxy idea at layer 2, it can be easily integrated with layer-2 service discovery to enable clients that are either connected to the network or not connected yet to discover services provided in the network. This is a feature that also enables a client device to save power by disconnecting from the network and only connecting when it needs a service and discovers that the network provides the service. Finally, embodiments of the present invention support server devices that also implement different higher-layer service discovery protocols, such as, but not limited to, UPnP and ZeroConf.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

We claim:

1. A method of server energy conservation in networks, comprising:
integrating a layer-2 service discovery proxy with an access point (AP) in said network, wherein said AP advertises the services on behalf of servers in said network to enable said servers can go to a low power state and conserve energy.

2. The method of claim 1, further comprising said server, if connected via wireless link, disconnecting from said network and periodically listening to beacons to determine if it should wake up and reconnect.

3. The method of claim 1, further comprising said server registering its services, device ID and any other desired server information with said AP proxy.

4. The method of claim 3, further comprising recording by the proxy in the AP the service information registered by servers, and then indicating in its beacons that these services are available.

5. The method of claim 4, further comprising omitting from the beacon frames some of the service details to conserve beacon bandwidth.

6. The method of claim 4, further comprising said server now going into a low power state and sleeping and only periodically waking up to listen to beacons and maintain connectivity.

7. The method of claim 4, further comprising said server completely disconnecting from said AP and periodically waking up and listening to beacons and checking if it needs to reconnect in case its service is requested.

8. The method of claim 4, further comprising using said Layer-2 proxy based service discovery includes discovering services advertised by said AP either through broadcast or directed messages, or a combination of both.

9. The method of claim 8, further comprising establishing an AP supported connection by when said client picks a particular server and requests to connect to it, said request will be recognized by said AP and if said server remains connected to said AP when it is in low power mode, said AP can wake it up.

10. The method of claim 9, wherein if said server is disconnected and only periodically examines beacons, said AP then indicates in its beacons that the server needs to reconnect and then it is the responsibility of said server to reestablish the connection when its device ID is seen in beacons.

11. The method of claim 10, wherein once said server wakes up and connects to said AP, said AP can forward the connection request so that said server and said client can connect to each other.

12. An apparatus, comprising:
a layer-2 service discovery proxy integrated with an access point (AP) in a network, wherein said AP advertises the services on behalf of servers in said network to enable said servers to go to a low power state and conserve energy.

13. The apparatus of claim 12, wherein said server disconnects from said network and periodically listens to beacons to determine if it should wake up and reconnect.

14. The apparatus of claim 12, further comprising said server registering its services, device ID and any other desired server information with said AP proxy.

15. The apparatus of claim 14, wherein said AP proxy records in the AP the service information registered by servers, and then indicates in its beacons that these services are available.

16. The apparatus of claim 15, further comprising omitting from the beacon frames some of the service details to conserve beacon bandwidth.

17. The apparatus of claim 15, wherein said server goes into a low power state and sleeps and only periodically wakes up to listen to beacons and maintain connectivity.

18. The apparatus of claim 15, further comprising said server completely disconnecting from said AP and periodically waking up and listening to beacons and checking if it needs to reconnect in case its service is requested.

19. The apparatus of claim 15, wherein said Layer-2 proxy based service discovery includes discovering services advertised by said AP either through broadcast or directed messages, or a combination of both.

20. The apparatus of claim 19, wherein when said client picks a particular server and requests to connect to it, it establishes an AP supported connection and said request will be recognized by said AP and if said server remains connected to said AP when it is in low power mode, said AP can wake it up.

21. The apparatus of claim 20, wherein if said server is disconnected and only periodically examines beacons, said AP then indicates in its beacons that the server needs to reconnect and then it is the responsibility of said server to reestablish the connection when its device ID is seen in beacons.

22. The apparatus of claim 21, wherein once said server wakes up and connects to said AP, said AP can forward the connection request so that said server and said client can connect to each other.
